(19) United States
(12) Patent Application Publication
(10) Pub. No.: US 2023/0069541 A1
(43) Pub. Date: Mar. 2, 2023

(54) SYSTEM AND METHOD FOR PROVIDING AN AUTOMATED VIRTUAL CLOSET

(71) Applicants: Soubir Acharya, Pleasantville, NY (US); Riik Acharya, Pleasantville, NY (US); Richik Acharya, Pleasantville, NY (US); Mahuya Chaudhury, Pleasantville, NY (US)

(72) Inventors: Soubir Acharya, Pleasantville, NY (US); Riik Acharya, Pleasantville, NY (US); Richik Acharya, Pleasantville, NY (US); Mahuya Chaudhury, Pleasantville, NY (US)

(21) Appl. No.: 17/898,117

(22) Filed: Aug. 29, 2022

Related U.S. Application Data
(60) Provisional application No. 63/238,120, filed on Aug. 28, 2021.

(51) Int. Cl. G06Q 30/06

(52) U.S. Cl. CPC G06Q 30/0643

(57) ABSTRACT

A system and a method for providing an automated virtual closet are disclosed herein for recommending and virtually trying clothing and fashion items. Authorized access of media information associated with user device(s) is received to identify and extract a fashion data pertaining to a plurality of wearable fashion items associated with corresponding users. Based on the extracted fashion data, an inventory of the plurality of wearable fashion items and the virtual closet is configured. Further, one or more categories are assigned to each of the plurality of wearable fashion items for thereby organising the inventory. Furthermore, based on one or more parameters, a set of wearable fashion items is prioritized from the plurality of wearable fashion items. The prioritized set of wearable fashion items is subsequently recommended to the respective users via the user device.

### TECHNICAL FIELD

The present subject matter generally relates to the field of Artificial Intelligence and metaverse environment, and more particularly to systems and methods for providing an automated virtual closet for recommending and virtually trying clothing and fashion items.

### BACKGROUND

This section presents a description of the related art to provide background information relating to the field of the disclosure. This description as disclosed in this section may contain some aspects of the art that may be related to various features of the present disclosure. However, the purpose of the description is only to enhance the understanding of the reader with respect to the present disclosure, and not admissions of the prior art.

When one is desperately trying to choose the right outfit to wear on an occasion, it is best to assume that their bed is covered in clothes while they are trying on every combination of clothes they can think of, looking in the mirror, and deciding they would rather wear something else. Also, there may be a scenario where they might be searching for something old that they think would look fashionable with their recent purchase but might not find it because their cluttered closet. In such conditions, getting dressed for any occasion takes a lot of unnecessary time and effort, and creates a huge mess to clean up afterwards.

Thus, most of the times it becomes difficult for people to keep a track of their clothes and accessories. Also, for people while preparing for an event, it becomes difficult to make a decision for what to wear to that event. It would be so much easier if people could virtually locate each item they own and try it on virtually so they would know which pieces of clothing, accessories, or shoes they could choose from.

Various attempts have been made to provide solutions related to virtual organisation, selection and trial of clothing and fashion items. Some solutions have been developed that require user(s) to upload to a digital storage, every single clothing/fashion item they own, to digitally organize these items and/or to provide relevant suggestions for these items. However, such systems or solutions could be extremely time consuming and/or inconvenient for the users.

In view of the above, disclosed herein are novel systems and methods for providing an automated virtual closet for recommending and virtually trying clothing and fashion items.

### SUMMARY

In order to provide a holistic solution to the above-mentioned limitations, there is provided an Artificial Intelligence (AI) based automated virtual closet for recommending fashion items to respective users and for facilitating the users to virtually try clothing by using their respective smart devices.

According to an embodiment of the present disclosure, there is provided a computer implemented method for providing an automated virtual closet. The method comprises: configuring a processing unit communicably connected to at least one of a plurality of user devices via at least one server in a communication network, the processing unit operating an Artificial Intelligence based (AI-based) module configured for: receiving authorized access of media information associated with the at least one of the plurality of user devices; accessing the media information to identify and extract fashion data, from the at least one of the plurality of user devices, the fashion data pertaining to a plurality of wearable fashion items associated with corresponding users; configuring the automated virtual closet by creating an inventory of the plurality of wearable fashion items, the inventory being created automatically based on the extracted fashion data; assigning one or more categories to each of the plurality of wearable fashion items for thereby organising the inventory; prioritizing, based on one or more parameters, a set of wearable fashion items from the plurality of wearable fashion items of the inventory; and recommending the prioritized set of wearable fashion items to the respective users via the at least one of the plurality of user devices.

According to an embodiment of the present disclosure, the media information includes at least one of photos, videos, images, emails, user calendar, and purchase data related to purchase of any wearable fashion items via one or more ecommerce platforms by respective users.

According to an embodiment of the present disclosure, the purchase data is extracted from the one or more ecommerce platforms and emails being operated on the at least one of the plurality of user devices, and one or more images of any purchased wearable fashion items.

According to an embodiment of the present disclosure, the one or more parameters for prioritizing the set of wearable fashion items includes at least one of the purchase data, a local weather-temperature condition, user calendar schedules, and a user input.

According to an embodiment of the present disclosure, the plurality of wearable fashion items includes wearable clothes, shoes, and accessories.

According to an embodiment of the present disclosure, the one or more categories include system-defined categories and user-defined categories, and the one or more categories are based on various metadata including brand name, size, colour, material type, date of purchase, cost, user preferences, weather appropriateness metadata.

According to an embodiment of the present disclosure, the method further comprises selecting at least one wearable fashion item from the prioritized set of wearable fashion items based on a first user selection; dressing a first 3D avatar of corresponding user by using the selected at least one wearable fashion item; predicting, at least one of a weather-temperature condition, a location detail and a lighting condition; and automatically generating, a customised background for the automatically dressed first 3D avatar based on the predicted at least one of the weather-temperature condition, the location detail and the lighting condition.

According to an embodiment of the present disclosure, the AI module is further configured for: automatically identifying any purchased wearable fashion items by performing at least one of a searching of the purchased wearable fashion items in a digital public domain, an initiation of a download action based on a user approval, a download action initiated by the user, and a purchase history.

According to an embodiment of the present disclosure, the method further comprises: comparing, a purchase data pertaining to purchase of any new wearable fashion item with existing purchased data associated with the inventory, updating the inventory based on the comparison, by one of: adding, one or more new purchased wearable fashion items in the inventory in an event of an unsuccessful comparison, adding to the one or more purchased wearable fashion items, an article-worn timestamp in an event of a successful comparison, wherein the article-worn timestamp is added to generate an article-worn timeline of the one or more purchased wearable fashion items, and automatically prioritising, the plurality of wearable fashion items in the inventory based on the article-worn timeline of the one or more purchased wearable fashion items.

According to an embodiment of the present disclosure, the method further comprises: creating, one or more walk-in closets in a metaverse environment based on the prioritized set of wearable fashion items; selecting, one or more prioritised purchased wearable fashion items from the one or more walk-in closets based on a second user selection; and dressing automatically, a second 3D avatar of the user in the metaverse environment based on the selected wearable fashion items from the one or more walk-in closets.

According to an embodiment of the present disclosure, the method further comprises: creating at least one potential destination as a simulation in the metaverse environment based on extracted weather information and user calendar inspection, and simulating the second 3D avatar of the user in the at least one potential destinations.

According to an embodiment of the present disclosure, the method further comprises: allowing other users to visit the one or more walk-in closets in the metaverse environment based on an invite from the user associated with one or more walk-in closets; performing one or more actions in the one or more walk-in closets based on an input received from the other users, the one or more actions including at least one of a chat action, a collaborating action, a feedback action and an action to create one or more merged walk-in closets; and storing data related to the one or more actions for at least one of a maintenance of a prediction timeline and a creation of one or more non-fungible tokens.

According to an embodiment of the present disclosure, a system for providing an automated virtual closet is provided. The system comprises: a storage unit operatively connected to a processing unit, the storage unit storing computer readable instructions; at least one of a plurality of user devices communicably connected to the processing unit via at least one server in a communication network, the processing unit executing the computer program instructions to operate an Artificial Intelligence based (AI-based) module configured to: receive authorized access of media information associated with the at least one of the plurality of user devices; access the media information to identify and extract fashion data, from the at least one of the plurality of user devices, the fashion data pertaining to a plurality of wearable fashion items associated with corresponding users; configure the automated virtual closet by creating an inventory of the plurality of wearable fashion items, the inventory being created automatically based on the extracted fashion data; assign one or more categories to each of the plurality of wearable fashion items for thereby organising the inventory; prioritize, based on one or more parameters, a set of wearable fashion items from the plurality of wearable fashion items of the inventory; and recommend the prioritized set of wearable fashion items to the respective users via the at least one of the plurality of user devices.

The afore-mentioned objectives and additional aspects of the embodiments herein will be better understood when read in conjunction with the following description and accompanying drawings. It should be understood, however, that the following descriptions, while indicating preferred embodiments and numerous specific details thereof, are given by way of illustration and not of limitation. This section is intended only to introduce certain objects and aspects of the present subject matter, and is therefore, not intended to define key features or scope of the subject matter of the present subject matter.

### BRIEF DESCRIPTION OF THE DRAWINGS

The figures mentioned in this section are intended to disclose exemplary embodiments of the claimed system and method. Further, the components/modules and steps of a process are assigned reference numerals that are used throughout the description to indicate the respective components and steps. Other objects, features, and advantages of the present subject matter will be apparent from the following description when read with reference to the accompanying drawings.

FIG. 1 illustrates a network architecture diagram, in accordance with exemplary embodiments of the present subject matter.

FIG. 2 illustrates inventory management based on a fashion data, in accordance with exemplary embodiments of the present subject matter.

FIG. 3 illustrates inventory management based on a fashion data, in accordance with exemplary embodiments of the present subject matter.

FIG. 4 illustrates prioritizing items in an inventory, in accordance with exemplary embodiments of the present subject matter.

FIG. 5 illustrates automated virtual closet provided on a user device, in accordance with exemplary embodiments of the present subject matter.

FIG. 6 is a flowchart illustrating the method for providing an automated virtual closet, in accordance with exemplary embodiments of the present subject matter.

### DETAILED DESCRIPTION

This section is intended to provide explanation and description of various possible embodiments of the present subject matter. The embodiments used herein, and various features and advantageous details thereof are explained more fully with reference to non-limiting embodiments illustrated in the accompanying drawings and detailed in the following description. The examples used herein are intended only to facilitate an understanding of ways in which the embodiments herein may be practiced and to further enable the person skilled in the art to practice the embodiments used herein. Also, the examples/embodiments described herein should not be construed as limiting the scope of the embodiments herein. Corresponding reference numerals indicate corresponding parts throughout the drawings.

The present disclosure relates to an automated virtual closet for recommending and virtually trying clothing and fashion items. Authorized access of media information associated with user device(s) may be received to identify and extract a fashion data pertaining to a plurality of wearable fashion items associated with corresponding users. Thereafter, automated virtual closet may be configured by creating, based on the extracted fashion data, an inventory of the plurality of wearable fashion items. Further, one or more categories may be assigned to each of the plurality of wearable fashion items for thereby organising the inventory. Based on parameter(s), a set of wearable fashion items may be prioritized from the plurality of wearable fashion items, to recommend the prioritized set of wearable fashion items to the respective users via the user device(s).

As used herein, ‘user device’ is a smart electronic device capable of communicating with various other electronic devices and applications via one or more communication networks. Examples of said user device include, but not limited to, a wireless communication device, a smart phone, a tablet, a desktop, a laptop, a computer system etcetera. The user device comprises: an input unit to receive one or more input data; an operating system to enable the computer device to operate; a processor to process various data and information; a memory unit to store initial data, intermediary data and final data; and an output unit. The processor associated with the computer device is an intelligent device or module, that is specifically programmed to process digital logics and perform analytical skills for analysing and processing various data and metadata or information, according to the embodiments of the present subject matter. The processor may be programmed by using executable instructions stored in the memory.

As used herein, ‘module’ or ‘unit’ refers to a device, a system, a hardware, a computer application, a framework, configured to execute specific functions or instructions according to the embodiments of the present subject matter. The module or unit may include a single device or multiple devices configured to perform specific functions as disclosed herein.

As used herein, a “processing unit” or “operating processor” includes one or more processors, microprocessors, microcomputers, microcontrollers, digital signal processors, central processing units, state machines, logic circuitries, and/or any devices that manipulate signals based on operational instructions. The processing unit may also refer to any logic circuitry for processing instructions. Among other capabilities, the processing unit may be configured to fetch and execute computer-readable instructions stored in the memory.

As used herein, “storage unit” or “memory unit” refers to a machine or computer-readable medium including any mechanism for storing information in a form readable by a computer or similar machine. The computer-readable medium may include a volatile memory, such as static random-access memory (SRAM) and dynamic random-access memory (DRAM), and/or non—volatile memory, such as read only memory (ROM), erasable programmable ROM, flash memories, hard disks, optical disks, magnetic tapes and/or other types of machine-accessible storage media. The storage unit stores at least the data that may be required by one or more units of the system to perform their respective functions.

As used herein, an ‘application’ may be a mobile-based application or a web-based application or any software application installed on one or more user devices, that perform one or more functions for an end user.

As used herein, a ‘metaverse environment’ is a collective virtual open space, created by convergence of virtually enhanced physical and digital reality.

As used herein, ‘network’ refers to a communication network including but not limited to a local area network (LAN), a wide area network (WAN), a metropolitan area network (MAN), a virtual private network (VPN), an enterprise private network (EPN), Internet, and a global area network (GAN).

Terms such as ‘connect’, ‘couple’ and other similar terms include a physical connection, a wired connection, a wireless connection, a logical connection or a combination of such connections including electrical, optical, RF, infrared, Bluetooth or other transmission media, as may be obvious to a person skilled in the art.

Terms such as ‘send’ ‘transfer’, ‘transmit’ and ‘receive’, ‘collect’, ‘obtain’ and other similar terms refer to transactions of data between various modules and units via wired or wireless connections.

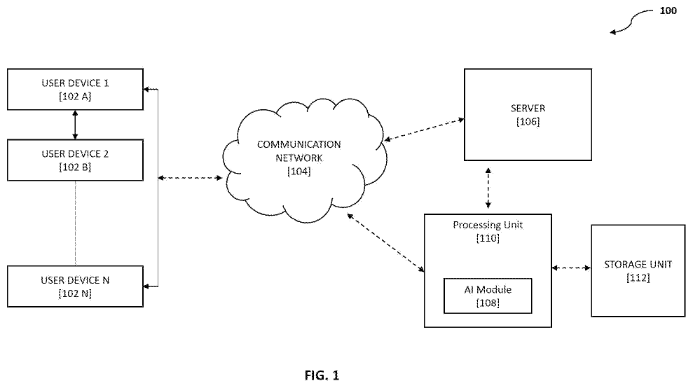

FIG. 1 illustrates a system architecture diagram, in accordance with exemplary embodiments of the present subject matter. A processing unit 110 is communicably connected to at least one of a plurality of user devices 102A, 102B-102N (hereinafter collectively or individually referred to as plurality of user device(s) 102), via at least one server 106 in a communication network 104. The processing unit 110 operates an Artificial Intelligence based (AI-based) module 108 configured for configuring the automated virtual closet.

The server maybe an electronic device configured to provide one or more services to at least one of the plurality of user devices 102 via the communication network 104. More specifically, an application may be configured on the server 106 and the user devices 102 to provide the automated virtual closet services to the users via respective at least one of the plurality of user devices 102.

The system 100 is configured to provide the automated virtual closet for recommending and virtually trying clothing and fashion items at one or more user devices 102 from the plurality of user devices 102, with the help of the interconnection between the components of the system. The storage unit 112 is configured to store computer readable instructions that is executed by the processing unit 110 to operate an Artificial Intelligence based (AI-based) module.

The Artificial Intelligence based (AI-based) module is operated by the processing unit 110, to provide the automated virtual closet. More specifically, the Artificial Intelligence based (AI-based) module, is configured to receive an authorized access of media information associated with the at least one of the plurality of user devices 102. To provide the authorized access of the media information to the AI-based module, the processing unit 110, via the server 106 across the communication network 104, communicates with at least one of the plurality of user devices 102. The media information may be stored at, at least one of a local storage and a remote storage communicably connected to the user devices 102. Also, the media information may include but not limited to at least one of videos, images, emails, user calendar, and purchase data related to purchase of any wearable fashion items made via one or more ecommerce platforms by respective users. Based on the media information, the AI-based module identifies and extract fashion data, from the at least one of the plurality of user devices 102. The fashion data pertains to a plurality of wearable fashion items associated with corresponding users. The plurality of wearable fashion items may include wearable clothes and accessories such as shirts, skirts, dresses, coats, blazers, trousers, watches, jewelries, caps, shoes, glasses, etc.

According to an embodiment of the subject matter, in order to identify and extract a fashion data pertaining to a plurality of wearable fashion items, the AI-based module may be configured to firstly access one or more email accounts associated with the user device 102 of the user. Also, the AI-based module may be configured to simultaneously access a list of brands that cover the fashion/retail space for clothes and accessories. In an event this list of brands is automatically maintained and updated at the system 100 based on at least one of an information of new vendors coming online and vendors detected from parsing a user data retrieved from the user device 102. Further, the AI-based module may be configured to classify one or more emails of the one or email accounts in groups of ‘Order Confirmations’, ‘Shipping Confirmations’, ‘Cancellations’, and ‘Returns’, using an email classifier. The email classifier is an AI model that may be built using emails received from active shoppers over the years. More specifically, important/relevant lines from all types of emails may be taken to train the email classifier to choose a right category for an email. For example, if during training the line “Your order has been shipped” is categorized as “Shipping Confirmation”, the email classifier will classify lines similar to this line on its own after training. Therefore, the email classifier after training learns to distinguish ecommerce related emails from other emails, and classifies emails into at least four groups including, ‘Order Confirmation’, ‘Shipping Confirmation’, ‘Return’, and ‘Cancellation’. Any email that is not related to one of these groups may be discarded by the email classifier. Additionally, once the email classifier picks out the emails which are receipts for clothing, it is further configured to parse such emails using entity recognition systems to figure out at least one of (1) keywords like: “Order”, “Confirmation”, “Purchase”, “Size: Small”, “Size: M”, “Size:10”, “Small”, “Medium”, “Large” etc. If such emails have an email attachment or an embedded image, and if such emails are confirmation emails to save pictures present in these emails.

Further, after parsing the emails, using entity recognition systems, that are receipts for clothing, a metadata may be extracted from the parsed data. The extracted metadata is the fashion data pertaining to the plurality of wearable fashion items associated with the user. In an embodiment the metadata of a wearable fashion item may include one or more of the following, but the disclosure is not limited thereto:
Official Image (i.e., an image from vendor)
Name of wearable fashion item
Type of wearable fashion item—inventory classification
When the wearable fashion item was purchased
Colour of the wearable fashion item (e.g., patterned/multi-coloured)
Brand of the wearable fashion item
Material of the wearable fashion item—create metadata—cashmere, down, wool—heavy & light etc.
Price of the wearable fashion item
Whether the wearable fashion item was on sale when bought
Size of the wearable fashion item (a number or category Small, Medium, or Large)
The wearable fashion item is for which gender—boy/girl/unisex
Is the wearable fashion item machine washable
Is the wearable fashion item eco-friendly
Season & year related to the wearable fashion item—Spring-Summer 2021>>>Spring/Summer—Pre-fall—Fall/Winter—Resort
Custom metadata
Tag from photos & social media related to the wearable fashion item
Tags from previous selections made of outfits
Weather appropriateness metadata to be created
Physical location the wearable fashion item is being stored

Also, the fashion data pertaining to the plurality of wearable fashion items may be identified and extracted based on a purchase data related to the plurality of wearable fashion items. As used herein the “purchase data” may include any information indicating a purchase of one or more items. The purchase data may be extracted from at least one of the one or more ecommerce platforms, emails being operated on the at least one of the plurality of user devices 102, one or more images and/or videos of any purchased wearable fashion items etc. In an implementation, the purchase data related to the plurality of wearable fashion items may be extracted from the set of e-commerce platforms using one or more customised plug-ins, wherein the one or more customised plug-ins identify at least a checkout detail of a set of purchased wearables from the set of e-commerce platforms. The identified checkout detail is then provided to the processing unit 110 for extraction of the purchase data. Further, the processing unit 110 is also configured to identify the fashion data pertaining to the plurality of wearable fashion items (for e.g., the images of the plurality of wearable fashion items) based on the extracted purchase data related to the wearable fashion items. In an implementation, the processing unit 110 may be configured to automatically identify any purchased wearable fashion items (i.e., image(s) of any purchased wearable fashion items) by performing at least one of a searching of the purchased wearable fashion items in a digital public domain, an initiation of a download action based on a user approval, a download action initiated by the user, and a purchase history. Based on the media information a purchase data related to one or more wearable fashion items is extracted and no corresponding images of said one or more wearable fashion items are identified in the accessed images, the processing unit 110 may use one or more keywords (for e.g., website, brand, item name/description etc.) to search for a relevant image in the public domain. It is almost certain to find a match if the purchase is recent. In a scenario, if it is reasonably certain that the processing unit 110 found the right image, it sends at the user device 102 an optional notification. In an event if the user of the user device 102 is not in agreement, the processing unit 110 is configured to request the user to download the relevant image or take a picture of it on the user device 102 and then the processing unit 110 saves said relevant image/picture automatically, after the downloading or picture saving has occurred on the user device 102. Also, in the given event, if the user takes this course of action, the processing unit 110 is also configured to track and saves the action taken (such as website visited etc.), and use it for subsequent image search for automatically identifying purchased wearable fashion item(s).

Further, in an event if the processing unit 110 is unable to find a relevant image of a wearable fashion item of the user (which is more likely to be true for historical purchases), or if the processing unit 110 is not sure if an image is a relevant image, the processing unit 110 is configured to send the user a message after a download of two or more possibly relevant images has occurred. The user via the message is requested to choose final relevant image(s) from the downloaded two or more possibly relevant images. If the final relevant image(s) are selected by the user, the processing unit 110 downloads the same and scrubs all the information. If no final relevant image is selected by the user, the processing unit 110 deletes the downloaded two or more possibly relevant images and requests the user to download the relevant image or take a picture of it on the user device 102.

Also, in an embodiment, to find a relevant image of a wearable fashion item of the user, the processing unit 110 may be configured to transmit a request on the user device 102 for receiving a user permission for accessing a purchase history when next time the user logs in to a retailer website. The purchase history on the website is almost sure to have a lot of useful metadata including the relevant image of the wearable fashion item.

Further, to find a relevant image of a wearable fashion item of the user, the AI-based module may gain access to user's photos (stored on the local and/or remote storage of the user device 102) and may request the user for an image with a clear visibility of the user's face. This image may then be used by the AI-based module in subsequent steps to match photos/images that have the user in it. More specifically, the AI-based module may analyse all photos stored in the user device 102 and scans each photo for user's face and clothing articles using an AI model which can use image search into the photos and extract relevant bounding boxes of articles of interest. The AI model therefore may extract photos with clothing articles, and/or photos with user's face, from accessed photos. Thereafter, the AI model extracts all the bounding boxes from the extracted photos and if the AI model doesn't find the photos with the user's face or there are no photos of the clothes, no action will be taken by the AI model. If there are only photos of clothes, the AI model assumes that they are the user's clothes and save the bounding box coordinates. Further, for each bounding box, the AI-based module is configured to identify clothing article and then extracts all possible metadata such as image, brand, timestamp, type, season, color, geolocation etc. In an implementation, for extraction of the metadata a secondary AI model may be used, wherein said secondary AI model is trained to recognize brand, clothing type and other attributes from one or more images after a bounding box is used to extract one or more relevant image patches.

According to an embodiment of the present disclosure, the AI-based module may also implement an AI model to determine what kind of weather conditions that clothing is being worn in. For example, if there are blue skies, or there is evidence of sunlight, the AI-based module can tell it's sunny. If there are grey skies, the AI-based module can tell it's cloudy. If the user is taking a picture under an umbrella in the rain, the AI-based module can tell raining. The AI-based module may use such metadata for suggesting clothes to wear in subsequent flows as a function of the weather forecast.

Further, after identification and extraction of the fashion data pertaining to the plurality of wearable fashion items associated with corresponding users, the AI-based module configures the automated virtual closet. The automated virtual closet is configured by creating an inventory of the plurality of wearable fashion items, the inventory being created automatically based on the extracted fashion data.

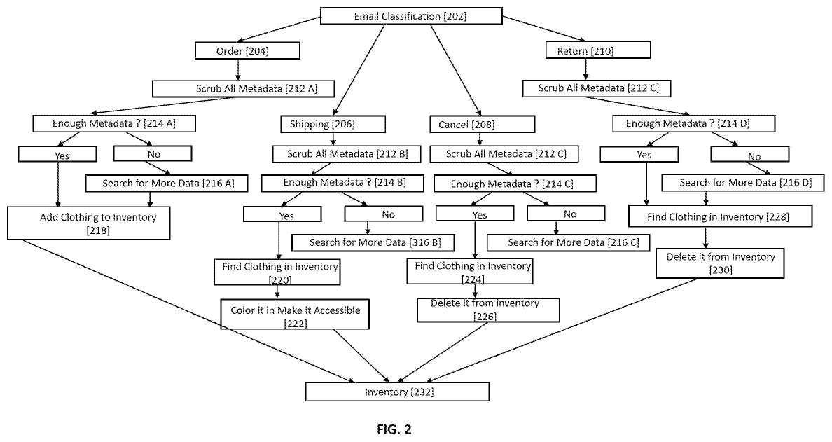

FIG. 2 illustrates an inventory management process based on a fashion data, in accordance with exemplary embodiments of the present subject matter. At step 202 various emails are classified into one or more categories including at least an order category, a shipping category 206, a cancel category 208 and a return category 210. For each category all metadata (fashion data) is scrubbed [see steps 212 A-212 D]. At this point, it is identified that whether or not the scrubbed metadata is enough. In case the metadata scrubbed for each category is not enough, then at steps [216 A]-[216 D] it is depicted that more data is searched. Also, in case for the order category 204, if the metadata is enough at step 218 a clothing corresponding to the metadata is added to an inventory 232. Further, in case for the shipping category 206, if the metadata is identified as ‘enough’ at step 220, a clothing corresponding to the metadata is identified in the inventory 232, wherein said identified clothing is then coloured and made accessible at 222. Also, in case for the cancel category 208, if the metadata is enough at step 224 a clothing corresponding to the metadata is identified in the inventory 232, wherein said identified clothing is then deleted from the inventory 232 at step 226. Further, in case for the return category 210, if the metadata is enough at step 228, a clothing corresponding to the metadata is identified in the inventory 232, wherein said identified clothing is then deleted from the inventory 232 at step 230.

The processing unit 110 is configured to compare, a purchase data pertaining to purchase of any new wearable fashion item with existing purchased data associated with the inventory. Thereafter, the processing unit 110 is configured to update the inventory based on the comparison, by one of: (1) adding, in an event of an unsuccessful comparison, one or more new purchased wearable fashion items to the inventory, (2) adding, in an event of a successful comparison, an article-worn timestamp to the one or more purchased wearable fashion items, wherein the article-worn timestamp is added to generate an article-worn timeline of the one or more purchased wearable fashion items, and, (3) automatically prioritizing, the plurality of wearable fashion items in the inventory based on the article-worn timeline of the one or more purchased wearable fashion items. More specifically, the processing unit 110 checks the inventory for duplicates of image(s) of wearable fashion item(s) using image matching techniques, wherein two images only have to be nearly identical to be a match because hundred percent identical is near impossible. The inventory is checked for duplicates of images by creating an embedding (a vector representation) of source and target images. Once these embeddings exist a simple vector operation like cosine distance can determine proximity of the images and potential match. If an item in the inventory is a match, then a timestamp (of a source image) is added to the inventory. This timestamp indicates when the article was worn and over time builds a timeline for this article and can be used to predict when and where it might be worn in the future.

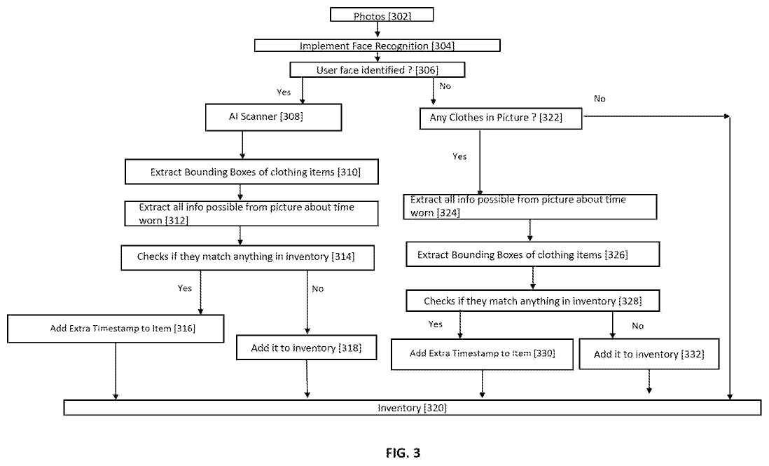

FIG. 3 depicts a face recognition technique implemented on photos 302 accessed from a user device 102. Thereafter, at step 306 it is determined whether face of a user of the user device 102 is identified from the photos 302. In case the face of the user is identified in the photos 302, an AI scanner 308, at step 310 extracts bounding boxes of clothing item(s) from the photos 302. Further, at step 312 a time worn information of the clothing item(s) is extracted and at 314 it is checked if the clothing item(s) match with any item present in an inventory 320. In case of the successful match the inventory 320 is updated at step 316 by adding an extra time stamp to the matched item and in case of unsuccessful match at step 318 the clothing item(s) are added to the inventory 320. In case the face of the user is not identified in the photos 302, at step 322 it is identified that if any clothing item(s) are present in the photos 302. If no clothing item(s) are present in the photos 302 no further action is taken on the inventory 320, otherwise at step 324 a time worn information of the clothing item(s) is extracted and at step 326 bounding boxes of clothing item(s) from the photos 302 are extracted. Further at step 328 it is checked if the clothing item(s) match with any item present in an inventory 320. In case of the successful match the inventory 320 is updated at 330 by adding an extra time stamp to the matched item and in case of unsuccessful match at 332 the clothing item(s) are added to the inventory 320.

Once the automated virtual closet is configured by creating the inventory of the plurality of wearable fashion items, the AI-based module assigns one or more categories to each of the plurality of wearable fashion items for thereby organising the inventory. The one or more categories are based on various metadata including brand name, size, colour, material type, date of purchase, cost, user preferences, and weather appropriateness metadata etc. Also, the one or more categories include at least one of one or more system-defined categories and one or more user-defined categories. For example, if a user wants to create custom categories, the user can do so as well. The user can move any item in the inventory to a different category if they prefer. Alternatively, the user can create capsule categories of items they always want to have at the ready, for e.g., a favourite green dress, yellow hat and gold shoes can be saved together in a custom category regardless of its industry designation. Similarly, if the user wishes to structure the inventory to look more like their own wardrobe and tag storage details, they can do so as well.

Further, the AI-based module is also configured to prioritize, based on one or more parameters, a set of wearable fashion items from the plurality of wearable fashion items of the inventory. The one or more parameters for prioritizing the set of wearable fashion items includes at least one of the purchase data, a local weather-temperature condition, user calendar schedules, and a user input. For example, one or more wearable fashion items that are recently purchased may be prioritized, or one or more wearable fashion items that are suitable for a local weather-temperature condition may be prioritized, or one or more wearable fashion items that are suitable for a meeting event identified from a user calendar schedule may be prioritized, or one or more wearable fashion items that are preferred by a user may be prioritized.

Furthermore, in an implementation for prioritization, one or more wearable fashion items are split into four categories based on season (i.e., a season as defined by the fashion industry): Spring/Summer, Pre-Fall, Fall-Winter, and Resort. Only items in one specific category will be available depending on what time it is. Further, the one or more wearable fashion items are prioritized in the inventory based on how recently user wore them, how recently user bought them, and if they are in user's seasonal category or not. Everything in the user's seasonal category will be placed at the front of the inventory. Also, a cycle is of N days (say for e.g., 15 days) by default but may be changed by the user or learned by the AI-based module. When the user wears an outfit and clicks “Done”, all the clothing items are moved to the back of the inventory of whichever item type they are, but not behind the seasonal categories of other clothes. Additionally, when the season changes, all the items that are in the front of the inventories will be moved to the back and every item in the new seasonal category will move up to the front. Also, as part of daily recommendations, the weather forecast is obtained (using standard APIs) and the user's calendar is consulted to use the daily schedule as a predictive element for article suggestion. Furthermore, the AI-based module may also configure a weather filter which pushes one or more wearable fashion items that are preferable within the weather conditions to the very front of the inventory. For example, if it's sunny and hot, a T-shirt will be at the front of the inventory rather than a long-sleeve shirt, because the T-shirt's temperature range is more likely to contain the temperature on that day. The user can turn this weather filter off. Further, the AI-based module may also configure a calendar filter that is also useful in suggesting clothes to wear based on destinations or venues (going to the airport, meeting friends, business meeting etc.). In an implementation an AI model is built which continuously learns which articles are appropriate to wear in the current weather and appropriate venue (meeting, travel) jointly to make these suggestions.

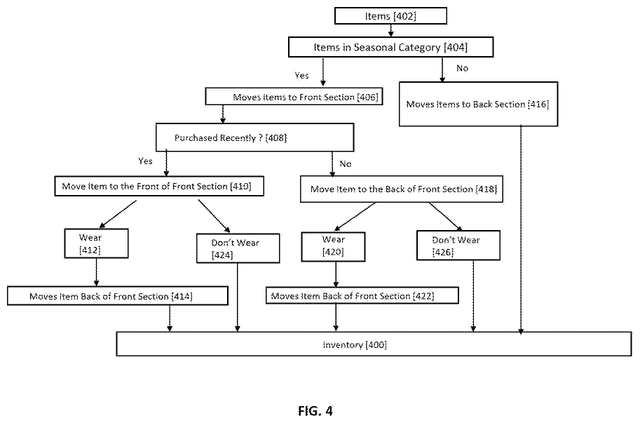

FIG. 4 illustrates prioritizing items in an inventory, in accordance with exemplary embodiments of the present subject matter. At step 404 it is identified whether or not the items 402 are categorised in a seasonal category. In an event the items 402 are not categorised in the seasonal category, the items 402 are moved to back sections of the inventory 400 (as depicted at step 416). Also, in an event the items 402 are categorised in the seasonal category, 406 depicts that such items are moved to the front section of the inventory. Further at step 408 it is identified that whether these items 402 are purchased recently. In an event said items 402 are purchased recently, 410 depicts that the recently purchased items are moved to front of the front section of the inventory. In case the user selects the recently purchased items to wear 412, the selected recently purchased items are then moved back of the front section 414. Also, in case no user selection is made, no further action will be taken 424. Furthermore, in an event if the items 402 are not purchased recently, 418 depicts that these items are moved to back of the front section of the inventory. In case the user selects any of these items to wear 402, the selected items are then moved back of the front section 422. Also, in case no user selection is made, no further action will be taken 426.

After prioritizing the set of wearable fashion items, the AI-based module is configured to recommend the prioritized set of wearable fashion items to the respective users via the at least one of the plurality of user devices 102. For instance, the processing unit 110 provides on the at least one of the plurality of user devices 102, an access to the automated virtual closet, wherein the automated virtual closet displays on a display unit of the at least one of the plurality of user devices 102, the prioritized set of wearable fashion items as one or more recommendations.

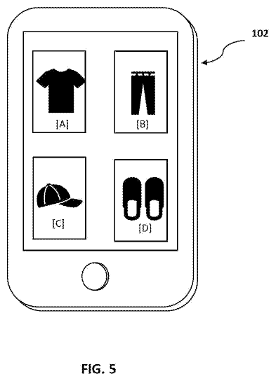

FIG. 5 illustrates automated virtual closet provided on a user device, in accordance with exemplary embodiments of the present subject matter. The figure depicts few prioritized wearable fashion items as [A], [B], [C] and [D] that may be displayed on a display screen of the user device. The user is thus shown or recommended the selected items and facilitated to make a choice to wear the items if desired.

In an embodiment, the AI-based module may be configured to select at least one wearable fashion item from the prioritized set of wearable fashion items based on a first user selection. The AI-based module is then configured to dress a first 3D avatar of corresponding user by using the selected at least one wearable fashion item. Thereafter, the AI-based module predict, at least one of a weather-temperature condition, a location detail and a lighting condition based on a user data accessed from at least one of the plurality of user devices. Also, the AI-based module is further configured to automatically generate, a customised background for the automatically dressed first 3D avatar based on the predicted at least one of the weather-temperature condition, the location detail and the lighting condition. More specifically, in an implementation, to virtually try one or more wearable fashion items, a user, via a respective user device 102, is presented with multiple choices which include, to import an existing avatar, to use a stock avatar, or to use a user picture to generate an avatar. The avatar is generated by the processing unit 110 with generic clothing. For instance, the processing unit 110 using the AI-based module takes the user picture and generates the user avatar preserving facial features, hair and additional features if present in the picture. Further, at recommendation time (daily or at other cadence) when a user selects wearable fashion articles from suggestions from the automated virtual closet, the avatar is dressed with the selected articles. The problem of “dressing” the avatar is hard because it is not simply a problem of overlaying clothing images with selected pictures of clothes but the appearance of clothes being worn in a “natural” way on a 3D avatar model that is capable of a 360° view with the outfit being preserved through rotation. Therefore, in an implementation the following steps may be taken for “dressing” the avatar in best possible manner.

Firstly, the clothes on the existing avatar are deleted and the selected articles are mapped to appropriate locations in the avatar. Further, an AI generative model is used to take the avatar and the set of clothes, for generation of a realistic “dressed” avatar. (The model may be trained on stock avatars with open datasets of clothing items which translates to a specific avatar and specific clothes). Thereafter, a specific background is generated for the avatar based on the weather forecast and guess at where the user is headed—for example—indoors, night-time, restaurant etc. The processing unit 110 uses the weather forecast, a “guess” at where the user is going—peeks at the user's calendar and find an appropriate background image from one or more open datasets and then use a guess at potential lighting conditions to create the right luminance for the outfit.

The processing unit 110 is further configured to send a request to the user for feedback if the “guess” was right and use the feedback to “re-enforce” choices that were made. The user feedback is collected on the look and fit of the avatar. The user can use voice to indicate specific feedback like the “hat is at a weird angle”. This feedback is converted to text and translated to a specific datapoints like hat off by 30 degrees which is used in offline training and adjustments to the learning process.

Furthermore, in an implementation, the processing unit 110 is also configured to create, one or more walk-in closets (room full of organized clothes) in a metaverse environment based on the prioritized set of wearable fashion items. Thereafter, the processing unit 110 is configured to select, one or more prioritised purchased wearable fashion items from the one or more walk-in closets based on a second user selection. Also, the processing unit 110 is then configured to dress automatically, a second 3D avatar of the user in the metaverse environment based on the selected wearable fashion items from the one or more walk-in closets.

Additionally, the processing unit 110 is also configured to create at least one potential destination as a simulation in the metaverse environment based on extracted weather information and user calendar inspection. Thereafter, the processing unit 110 is configured to simulate the second 3D avatar of the user in the at least one potential destinations. Furthermore, in an implementation, the processing unit 110 is also configured to allow other users to visit the one or more walk-in closets in the metaverse environment based on an invite from the user associated with one or more walk-in closets. The processing unit 110 is then configured to perform one or more actions in the one or more walk-in closets based on an input received from the other users, the one or more actions including at least one of a chat action, a collaborating action, a feedback action and an action to create one or more merged walk-in closets. Further the processing unit 110 is configured to store data related to the one or more actions for at least one of a maintenance of a prediction timeline and a creation of one or more non-fungible tokens.

Further, an example of a multiverse that can be adapted may be any virtual collaboration platform that runs in a browser. With the virtual collaboration platform, a user can create his own 3D spaces with a single click and invite others to join using a URL. The virtual collaboration platform may be configured for anyone who wants to connect with others remotely. It's a great way to bring communities together in a shared virtual space. Host a conference, teach a class, showcase art, or just hang out with friends. The virtual collaboration platform makes it easy to connect and share images, videos, 3D models, and more. With a virtual collaboration platform's spatialized audio one can have conversations with everyone together or break out into smaller groups—just like one can do in the real world. In an implementation, the flow is as follows if a particular virtual collaboration platform is used (similar techniques can be used with other metaverses).

Firstly, a personalized closet-verse (a room in the particular virtual collaboration platform) is created. Thereafter, the prioritized set of wearable fashion items are used to create assets in the closet-verse using all items in the closet organized by season/recency. This is done one-time and synced as the cloud inventory and seasons change. Further, an “event” is created once the user selects clothing articles, and a 3D-avatar is created and dressed. The avatar is then inserted in the closet-verse. The user is free to view the avatar in the closet-verse and simulate the avatar in potential destinations. Potential destinations are created automatically as simulations based on weather and the user's calendar inspection. Also, the user may then choose to invite others to join the closet-verse—these users may or may not registered with an automated virtual closet and may simply join to comment, collaborate and chat both in the closet view or the simulation view. If these other users are also registered with an automated virtual closet, they can choose to create a merged closet-verse or have their own “dressed” 3D-avatars interacting in the simulation destinations. Furthermore, a snapshot of these interactions is also maintained as a timeline for future predictions and as “memories” for future playback and may be recorded as shared NFTs (Non-fungible tokens).

Furthermore, in an implementation, all interactions with invitees may be recorded by the processing unit 110 and used for making suggestions in the future. For example, if invites to the closet-verse likes the outfit and/or makes specific comments these may be considered feedback and “labels” for future predictions/suggestions as the AI-based module learns. Additionally, the AI-based module learns how the outfit “looks” based on physics and lighting in the closet-verse and can shape future “auto-dressing” of avatars.

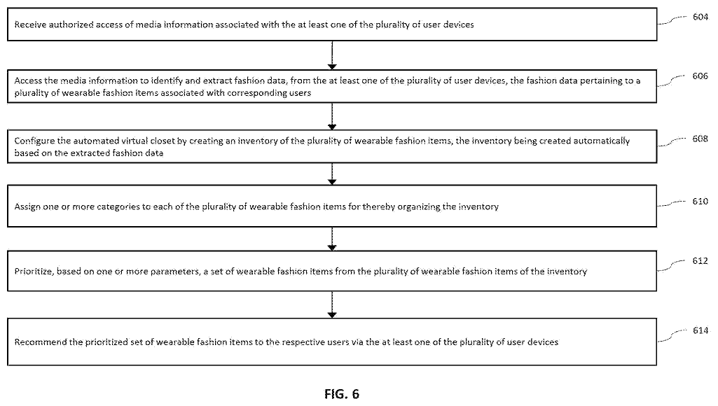

FIG. 6 is a flowchart illustrating the method for providing an automated virtual closet, in accordance with exemplary embodiments of the present subject matter. In an implementation the method is performed by the system 100.

At step 604, authorized access of media information is received. The media information is associated with the at least one of the plurality of user devices. The method is initiated by configuring the processing unit 110, communicably connected to the at least one of the plurality of user devices, via the at least one server in the communication network 104. The method also encompasses configuring the processing unit 110 for operating the Artificial Intelligence based (AI-based) module configured for providing the automated virtual closet. The media information may be accessed from at least one of the local storage, and the remote storage of at least one of the plurality of user devices. Also, the media information may include but not limited to at least one of videos, images, emails, user calendar, and purchase data related to purchase of any wearable fashion items made via one or more ecommerce platforms by respective users. The AI module 108 is further configured for automatically identifying any purchased wearable fashion items by performing at least one of a searching of the purchased wearable fashion items in a digital public domain, an initiation of a download action based on a user approval, a download action initiated by the user, and a purchase history.

At step 606, the media information is accessed by the AI module 108 to identify and extract fashion data, from the at least one of the plurality of user devices. The fashion data pertains to a plurality of wearable fashion items associated with corresponding users. The plurality of wearable fashion items may include wearable clothes, shoes, and accessories such as shirts, blazers, trousers, sweaters, scarfs, skirts, caps, ties, handbags, jewellery items etc. In order to identify and extract the fashion data, the AI-based module may utilise media information such as one or more videos, images, emails, user calendar, and purchase data related to purchase of any wearable fashion items, retrieved from the user device. The purchase data is extracted from the one or more ecommerce platforms and emails being operated on the at least one of the plurality of user devices, and one or more images of any purchased wearable fashion items.

In an embodiment, the AI module 108 is further configured for comparing, a purchase data pertaining to purchase of any new wearable fashion item with existing purchased data associated with the inventory. The inventory is updated based on the comparison by one of: adding one or more new purchased wearable fashion items in the inventory in an event of an unsuccessful comparison, adding to the one or more purchased wearable fashion items, an article-worn timestamp in an event of a successful comparison, wherein the article-worn timestamp is added to generate an article-worn timeline of the one or more purchased wearable fashion items, and automatically prioritising, the plurality of wearable fashion items in the inventory based on the article-worn timeline of the one or more purchased wearable fashion items.

At step 608, the automated virtual closet is configured by creating an inventory of the plurality of wearable fashion items, the inventory being created automatically based on the extracted fashion data which may include any purchase data pertaining to purchase of any new wearable fashion item with existing purchased data associated with the inventory. According to an embodiment of the present subject matter, the user is facilitated to select at least one wearable fashion item from the prioritized set of wearable fashion items. The selected at least one wearable item may be used for dressing a first 3D avatar of corresponding user by using the selected at least one wearable fashion item. Thereafter, at least one of a weather-temperature condition and a location detail and a lighting condition may be predicted. A customised background is automatically generated for the automatically dressed first 3D avatar based on the predicted at least one of the weather-temperature condition, the location detail and the lighting condition.

At step 610, one or more categories may be assigned to each of the plurality of wearable fashion items for thereby organising the inventory. The one or more categories include system-defined categories and user-defined categories, and the one or more categories are based on various metadata including brand name, size, colour, material type, date of purchase, cost, user preferences, weather appropriateness metadata.

At step 612, based on one or more parameters, a set of wearable fashion items from the plurality of wearable fashion items of the inventory may be prioritized for the user.

At step 614, the prioritized set of wearable fashion items is recommended to the respective users via the at least one of the plurality of user devices. The one or more parameters for prioritizing the set of wearable fashion items include at least one of the purchase data, a local weather-temperature condition, user calendar schedules, and a user input.

In addition, one or more walk-in closets in a metaverse environment may be created based on the prioritized set of wearable fashion items. Further, one or more prioritised purchased wearable fashion items may be selected from the one or more walk-in closets based on a second user selection; and a second 3D avatar of the user in the metaverse environment may be dressed up based on the selected wearable fashion items from the one or more walk-in closets.

At least one potential destination may be created as a simulation in the metaverse environment based on extracted weather information and user calendar inspection. The second 3D avatar of the user may be simulated in the at least one potential destinations. Other users may be allowed to visit the one or more walk-in closets in the metaverse environment based on an invite from the user associated with one or more walk-in closets. Further, one or more actions may be performed in the one or more walk-in closets based on an input received from the other users, the one or more actions including at least one of a chat action, a collaborating action, a feedback action and an action to create one or more merged walk-in closets. Data related to the one or more actions may be stored for at least one of a maintenance of a prediction timeline and a creation of one or more non-fungible tokens.

Thus, the present subject matter discloses a novel solution of providing an automated virtual closet for recommending and virtually trying clothing and fashion items. A technical advancement over the existing solutions is exhibited by the system and the method as disclosed above. The automated virtual closet is constructed based on media information accessed from a user device of the user. The present described solution is also technically advanced over the existing solutions as it configures the automated virtual closet by creating and organising a virtual inventory based on: 1) automatically identified wearable fashion items of a user, and 2) one or more categories assigned to each of the automatically identified wearable fashion items. Moreover, prioritising the wearable fashion items of the user in the automated virtual closet based on various parameters is also an advanced feature of the present subject matter. Further, providing various recommendations to the users on respective user devices for clothing and fashion items via an automated virtual closet provided in at least one of an application and a metaverse environment is yet another advanced feature of the disclosed subject matter. Limitations of the existing solutions are overcome by the present subject matter, as it provides a solution to dress a 3D avatar of a user and to adjust a background environment of the 3D avatar on a user device of the user, for virtually trying clothing and fashion items. Additionally, the present subject matter is also technically advanced over the existing solutions as it provides a solution that can automatically update the automated virtual closet based on a feedback data.

The term exemplary is used herein to mean serving as an example. Any embodiment or implementation described as exemplary is not necessarily to be construed as preferred or advantageous over other embodiments or implementations. Further, the use of terms such as including, comprising, having, containing and variations thereof, is meant to encompass the items/components/process listed thereafter and equivalents thereof as well as additional items/components/process.

Although the subject matter is described in language specific to structural features and/or acts, it is to be understood that the subject matter defined in the claims is not necessarily limited to the specific features or process as described above. In fact, the specific features and acts described above are disclosed as mere examples of implementing the claims and other equivalent features and processes which are intended to be within the scope of the claims.

What is claimed is:

1. A computer implemented method for providing an automated virtual closet, the method comprising:
configuring a processing unit communicably connected to at least one of a plurality of user devices via at least one server in a communication network, the processing unit operating an Artificial Intelligence based (AI-based) module configured for:
receiving authorized access of media information associated with the at least one of the plurality of user devices;
accessing the media information to identify and extract fashion data, from the at least one of the plurality of user devices, the fashion data pertaining to a plurality of wearable fashion items associated with corresponding users;
configuring the automated virtual closet by creating an inventory of the plurality of wearable fashion items, the inventory being created automatically based on the extracted fashion data;
assigning one or more categories to each of the plurality of wearable fashion items for thereby organising the inventory;
prioritizing, based on one or more parameters, a set of wearable fashion items from the plurality of wearable fashion items of the inventory; and
recommending the prioritized set of wearable fashion items to the respective users via the at least one of the plurality of user devices.

2. The computer implemented method of claim 1, wherein the media information includes at least one of photos, videos, images, emails, user calendar, and purchase data related to purchase of any wearable fashion items via one or more ecommerce platforms by respective users.

3. The computer implemented method of claim 2, wherein the purchase data is extracted from the one or more ecommerce platforms and emails being operated on the at least one of the plurality of user devices, and one or more images of any purchased wearable fashion items.

4. The computer implemented method of claim 1, wherein the one or more parameters for prioritizing the set of wearable fashion items includes at least one of the purchase data, a local weather-temperature condition, user calendar schedules, and a user input.

5. The computer implemented method of claim 1, wherein the plurality of wearable fashion items includes wearable clothes, shoes, and accessories.

6. The computer implemented method of claim 1, wherein the one or more categories include system-defined categories and user-defined categories, and the one or more categories are based on various metadata including brand name, size, colour, material type, date of purchase, cost, user preferences, weather appropriateness metadata.

7. The computer implemented method of claim 1, further comprising:
selecting at least one wearable fashion item from the prioritized set of wearable fashion items based on a first user selection;
dressing a first 3D avatar of corresponding user by using the selected at least one wearable fashion item;
predicting, at least one of a weather-temperature condition, a location detail and a lighting condition; and
automatically generating, a customised background for the automatically dressed first 3D avatar based on the predicted at least one of the weather-temperature condition, the location detail and the lighting condition.

8. The computer implemented method of claim 1, wherein the AI module is further configured for:
automatically identifying any purchased wearable fashion items by performing at least one of a searching of the purchased wearable fashion items in a digital public domain, an initiation of a download action based on a user approval, a download action initiated by the user, and a purchase history.

9. The computer implemented method of claim 1, further comprising:
comparing, a purchase data pertaining to purchase of any new wearable fashion item with existing purchased data associated with the inventory;
updating the inventory based on the comparison, by one of:
adding, one or more new purchased wearable fashion items in the inventory in an event of an unsuccessful comparison,
adding to the one or more purchased wearable fashion items, an article-worn timestamp in an event of a successful comparison, wherein the article-worn timestamp is added to generate an article-worn timeline of the one or more purchased wearable fashion items, and
automatically prioritising, the plurality of wearable fashion items in the inventory based on the article-worn timeline of the one or more purchased wearable fashion items.

10. The computer implemented method of claim 1, further comprising:
creating, one or more walk-in closets in a metaverse environment based on the prioritized set of wearable fashion items;
selecting, one or more prioritised purchased wearable fashion items from the one or more walk-in closets based on a second user selection; and
dressing automatically, a second 3D avatar of the user in the metaverse environment based on the selected wearable fashion items from the one or more walk-in closets.

11. The computer implemented method of claim 10, further comprising:
creating at least one potential destination as a simulation in the metaverse environment based on extracted weather information and user calendar inspection, and
simulating the second 3D avatar of the user in the at least one potential destinations.

12. The computer implemented method as claimed in claim 10, the method further comprises:
allowing other users to visit the one or more walk-in closets in the metaverse environment based on an invite from the user associated with one or more walk-in closets;
performing one or more actions in the one or more walk-in closets based on an input received from the other users, the one or more actions including at least one of a chat action, a collaborating action, a feedback action and an action to create one or more merged walk-in closets; and
storing data related to the one or more actions for at least one of a maintenance of a prediction timeline and a creation of one or more non-fungible tokens.

13. A system for providing an automated virtual closet, the system comprising:
a storage unit operatively connected to a processing unit, the storage unit storing computer readable instructions;
at least one of a plurality of user devices communicably connected to the processing unit via at least one server in a communication network, the processing unit executing the computer program instructions to operate an Artificial Intelligence based (AI-based) module configured to:
receive authorized access of media information associated with the at least one of the plurality of user devices;
access the media information to identify and extract fashion data, from the at least one of the plurality of user devices, the fashion data pertaining to a plurality of wearable fashion items associated with corresponding users;
configure the automated virtual closet by creating an inventory of the plurality of wearable fashion items, the inventory being created automatically based on the extracted fashion data;
assign one or more categories to each of the plurality of wearable fashion items for thereby organising the inventory;
prioritize, based on one or more parameters, a set of wearable fashion items from the plurality of wearable fashion items of the inventory; and
recommend the prioritized set of wearable fashion items to the respective users via the at least one of the plurality of user devices.

14. The system of claim 13, wherein the media information includes at least one of photos, videos, images, emails, user calendar, and purchase data related to purchase of any wearable fashion items via one or more ecommerce platforms by respective users.

15. The system of claim 14, wherein the purchase data is extracted from the one or more ecommerce platforms and emails being operated on the at least one of the plurality of user devices, and one or more images of any purchased wearable fashion items.

16. The system of claim 14, wherein the one or more parameters for prioritizing the set of wearable fashion items includes at least one of the purchase data, a local weather-temperature condition, user calendar schedules, and a user input.

17. The system of claim 13, wherein the plurality of wearable fashion items includes wearable clothes, shoes, and accessories.

18. The system of claim 13, wherein the one or more categories include system-defined categories and user-defined categories, and the one or more categories are based on various metadata including brand name, size, colour, material type, date of purchase, cost, user preferences, weather appropriateness metadata.

19. The system of claim 13, the AI module is further configured to:
select at least one wearable fashion item from the prioritized set of wearable fashion items based on a first user selection;
dress a first 3D avatar of corresponding user by using the selected at least one wearable fashion item;
predict, at least one of a weather-temperature condition, a location detail and a lighting condition; and
automatically generate, a customised background for the automatically dressed first 3D avatar based on the predicted at least one of the weather-temperature condition, the location detail and the lighting condition.

20. The system of claim 13, further configured to:
automatically identify any purchased wearable fashion items by performing at least one of a searching of the purchased wearable fashion items in a digital public domain, an initiation of a download action based on a user approval, a download action initiated by the user, and a purchase history.

21. The system of claim 13, further configured to:
compare, a purchase data pertaining to purchase of any new wearable fashion item with existing purchased data associated with the inventory;
update the inventory based on the comparison, by one of:
add, in an event of an unsuccessful comparison, one or more new purchased wearable fashion items to the inventory,
add, in an event of a successful comparison, an article-worn timestamp to the one or more purchased wearable fashion items, wherein the article-worn timestamp is added to generate an article-worn timeline of the one or more purchased wearable fashion items, and
automatically prioritize, the plurality of wearable fashion items in the inventory based on the article-worn timeline of the one or more purchased wearable fashion items.

22. The system of claim 13, further configured to:
create, one or more walk-in closets in a metaverse environment based on the prioritized set of wearable fashion items;
select, one or more prioritised purchased wearable fashion items from the one or more walk-in closets based on a second user selection; and
dress automatically, a second 3D avatar of the user in the metaverse environment based on the selected wearable fashion items from the one or more walk-in closets.

23. The system of claim 13, further configured to:
create at least one potential destination as a simulation in the metaverse environment based on extracted weather information and user calendar inspection, and
simulate the second 3D avatar of the user in the at least one potential destinations.

24. The system of claim 13, further configured to:
allow other users to visit the one or more walk-in closets in the metaverse environment based on an invite from the user associated with one or more walk-in closets;
perform one or more actions in the one or more walk-in closets based on an input received from the other users, the one or more actions including at least one of a chat action, a collaborating action, a feedback action and an action to create one or more merged walk-in closets; and
store data related to the one or more actions for at least one of a maintenance of a prediction timeline and a creation of one or more non-fungible tokens.
